(19) United States
(12) Patent Application Publication
(10) Pub. No.: US 2009/0199335 A1
(43) Pub. Date: Aug. 13, 2009

(54) CEILING MOUNTED HOIST SYSTEM

(75) Inventor: Carsten Guldmann, Risskov (DK)

Correspondence Address: ROBERTS MLOTKOWSKI SAFRAN & COLE, P.C.;Intellectual Property Department, P.O. Box 10064, MCLEAN, VA, 22102-8064, US

(73) Assignee: V. GULDMANN A/S, Aarhus N (DK)

(21) Appl. No.: 12/299,731

(22) PCT Filed: May 7, 2007
(86) PCT No.: PCT/DK2007/000216

§ 371 Date: Nov. 5, 2008

(30) Foreign Application Priority Data
May 5, 2006 (DK) PA 2006 00632

(51) Int. Cl. A61G 7/10

(52) U.S. Cl. 5/87.1

(57) ABSTRACT

A hoisting system (1) with a hoisting apparatus (2) for hoisting persons (4), e.g., physically handicapped persons, where the hoist system (1) includes at least one trolley (11) and at least one hoisting apparatus (2), which are integrated and provided assembled in a rail (9) arranged therefor, where the system is driven by at least one motor (14). By building the trolley (11) together with the hoisting apparatus (2), there is achieved the great advantage that the hoisting apparatus (2) is hidden inside the rail (9). Thus, a much more discreet and smart system is achieved where, otherwise, a large and unsightly hoisting apparatus would hang under the rail (9). Furthermore, an increased clearance between the hoist system (1) and the floor is attained.

### BACKGROUND OF THE INVENTION

1. Field of the Invention

The present invention concerns a hoist system with a hoisting apparatus for hoisting persons, e.g. physically handicapped persons, and which is connected to a trolley, where the trolley is disposed in a rail adapted therefore.

2. Description of Related Art

It is commonly knowledge to use lifting tools in connection with caring for physically handicapped persons. These lifting tools may e.g. be provided in rail systems mounted under the ceiling in private homes, in nursing homes or in hospitals. Alternatively, there are systems made as portals, where the legs of the portal stand on the floor. Moreover, there are systems which are mobile and collapsible.

In situations where the lifting tools are installed as a permanent system, there is often used a system where the lifting tool is moved or driven in rails under the ceiling. These rails are typically fastened directly under the ceiling, or may be fastened in suspended fittings mounted under the ceiling. Rail systems of this type are usually made of extruded aluminium sections with a sectional height adapted to the load intended for the rail and the maximum spacing between the mounting fittings of the rail.

Rail systems constructed with rails mounted along two parallel walls in a room are often used, and where between these rails there is provided a so-called crossbar which is embedded in the rails along the wall. This type of lifting tool, with as well as without crossbar rails, are in principle directly comparable to crane equipment known from the industry. However, there is the great difference that the equipment, when used for care in institutions or in private homes, is preferably to appear simple, discreet and smart, while at the same time being user friendly, cleaning friendly and sturdy.

All prior art systems are thus constructed so that a trolley is mounted in the rails, either a push trolley or a motor trolley, and in which a hoisting apparatus is either disposed permanently or may be coupled thereto according to need. Examples of such models are GH2+2, GH2 F and DH 1000 from the Danish firm V. Guldmann A/S.

The said models are all suited for performing hoisting of handicapped, sick or physically disabled persons, but common to the prior art systems is that the lifting height is not always sufficient, e.g. by low ceiling height. Another drawback of the prior art types is that the hoisting apparatus is neither particularly cleaning friendly nor nice to have suspended under the ceiling.

However, if using the type of hoisting apparatuses which are stored and/or transported on a carriage or similar, and which are coupled to the rail system when the hoist system is to be used, then the system is not suited to be used by the person to be lifted by himself only.

By prior art types of hoist systems, there are thus several inexpedient features which an apparatus according to the invention provides a solution to.

### SUMMARY OF THE INVENTION

It is the purpose of the invention to provide a hoist system with rails and with hoisting apparatus where the above mentioned inexpediencies are solved. This means that the system is user friendly, cleaning friendly and sturdy, while at the same time being nice, discreet and smart. Furthermore, it is the purpose of the invention to indicate a hoist system with maximum ground clearance.

The invention indicates a hoist system with a hoisting apparatus for hoisting persons, where the hoist system includes at least one trolley and at least one hoisting apparatus, which are built together and placed assembled in the rail, where the system is driven by at least one motor.

By building the trolley together with the hoisting apparatus, there is achieved the great advantage that the hoisting apparatus is hidden inside the rail. Hereby is achieved a much more discreetly and smartly appearing system where an otherwise large and unsightly hoisting apparatus would hang under the rail.

Another advantage obtained, which is not without importance in many cases, is that by mounting hoist systems in private homes there is often not the optimal ceiling height. Particularly in old houses where a hoist system is mounted under the ceiling, there is no possibility of lifting a person out of e.g. a bed, as the hoisting apparatus “steals” some of the lifting height. Prior art types of hoisting apparatuses and trolleys are typically taking up between 32 cm and 37 cm in height, though there are types available with a height about 16 cm, and to that the height of the rail is to be added. As mentioned above, the rail height depends on which load the system is designed for, and how close the fixing points are disposed, but typical rail heights are between about 8 cm and up to about 20 cm. The total height of a hoist system of the prior art types may thus easily amount to about 40 cm, or even up to about 60 cm. So, for utilising the ceiling height optimally, it is an advantage to mount the hoisting apparatus itself and its motor etc. inside the rail sections.

A hoisting apparatus according to the invention is furthermore more rapid to use than the type which is first to be coupled together with a trolley in that the hoisting strap is to be run out and subsequently connected to the trolley by a person stepping up on a stool or similar in order to reach. With a system according to the invention, the hoisting apparatus may be put into use rapidly, and the nursing staff may therefore assist more persons over the same time, as there is not so much waste of time in making the hoisting apparatus ready.

With a hoist system according to the invention, the rail height cannot, however, be minimised, but the height taken up by the sub-suspended hoisting apparatus itself, is now suddenly available.

A variant of a hoist system according to the invention is a push trolley, and a further variant is with a motor trolley driven by an electric motor. The two variants may be chosen freely according to need. However, it is particularly relevant with a motor trolley if the hoist system is to be operated by the physically handicapped person himself. By such a solution, there is achieved possibility that the handicapped can help himself to a large degree, and may not necessarily need help to go to the toilet, bathe and get up to sit in a chair or go to bed.

A variant of a hoist system with a hoisting apparatus according to the invention with a motor trolley is where the assembled unit has a first motor for driving the trolley and a second motor for driving the hoisting apparatus. This variant has the advantage that there is provided the possibility of lifting a person simultaneously with driving with the trolley.

A particularly preferred variant of the invention is where the assembled unit is with one motor, where trolley and hoisting apparatus are driven by one and the same motor. Hereby is achieved the possibility of making the mechanical construction smaller, as there is only to be provided a single motor in connection with trolley and hoisting apparatus.

In an embodiment of the invention, between motor and trolley and hoisting apparatus, respectively, there are means for shifting between operating the trolley and operating the hoisting apparatus. Thus there is a possibility of via the operating handles of the hoist system to engage the motor that is needed. Coupling and uncoupling trolley and hoisting apparatus, respectively, may be effected in several ways, e.g. in that the motor is provided with a through-going shaft which at both ends is provided with means for engaging corresponding means on trolley and hoisting apparatus, respectively. By displacing the motor shaft in longitudinal direction there may thus be shifted between two or more positions. Displacing the motor shaft may be effected manually or automatically via the operating handle.

Coupling and uncoupling may occur in many ways other than here described, as this is a known function and a skilled in the art producing this kind of mechanics may freely choose between a plurality of solutions, which are suited for this kind of coupling and uncoupling.

In order that a hoist system according to the invention is to be yet more discreet and cleaning friendly, the rail is designed with a narrow longitudinal opening, through which a lifting strap is passed from the built-in hoisting apparatus. To prevent dust and similar from being deposited in the interior of the rails, this narrow longitudinal opening or slot is provided with a flexible sealing, preferably a two-part lip seal. This sealing can be made of rubber or other suitable material. The sealing may also consist of brushes with a length covering the slot from one or both sides. This type of sealing is known i.a. from sealings at the bottom edge of doors.

The hoist system can be supplied with electric energy from at least one battery placed in connection with the assembled unit, and the rail or the system may be arranged so that the assembled unit is moved to a charging station for charging of the battery of the system at times where the hoist system is not used.

Yet a variant of a hoist system with a hoisting apparatus according to the invention is supplied with energy via electrically conducting elements in or at the rail. By this variant, there is always power on the apparatus, and it is immediately ready for use. Thus you are not dependent on remembering to set the system to charge. Hoist systems of this type are typically designed with low voltage motors that run on DC and are produced with motors only requiring 24 V without any problems. There are thus no essential safety problems associated with live conductors inside the rail system.

### BRIEF DESCRIPTION OF THE DRAWINGS

The invention is described in more detail with reference to the drawing, wherein:

FIG. 1 shows a system according to the invention in use;

FIG. 2 shows details regarding the built-together unit in the rail;

FIG. 3 shows a rail with integrated trolley and hoisting apparatus as seen from the end.

### DETAILED DESCRIPTION OF THE INVENTION

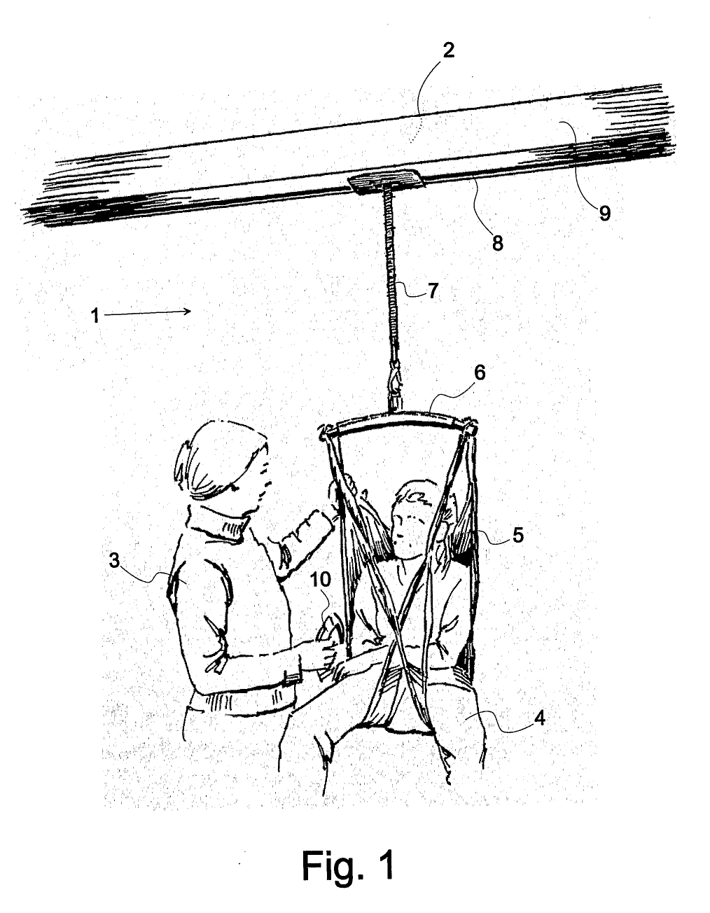

In FIG. 1 appears a hoisting system 1 with integrated hoisting apparatus 2 according to the invention in a situation of use, where an assistant 3 assists the physically handicapped 4 who is sitting in a so-called canvas 5. The canvas 5 is connected to the strap 7 of the hoisting apparatus 2 via a lifting bracket 6. The strap 7 disappears into a longitudinal slot 8 in the rail 9, which is mounted in a not shown way under the ceiling. The assistant 3 keeps his hand on the operating handle 10 that may be connected directly to the hoisting apparatus 2, or which may be designed as a wireless remote control.

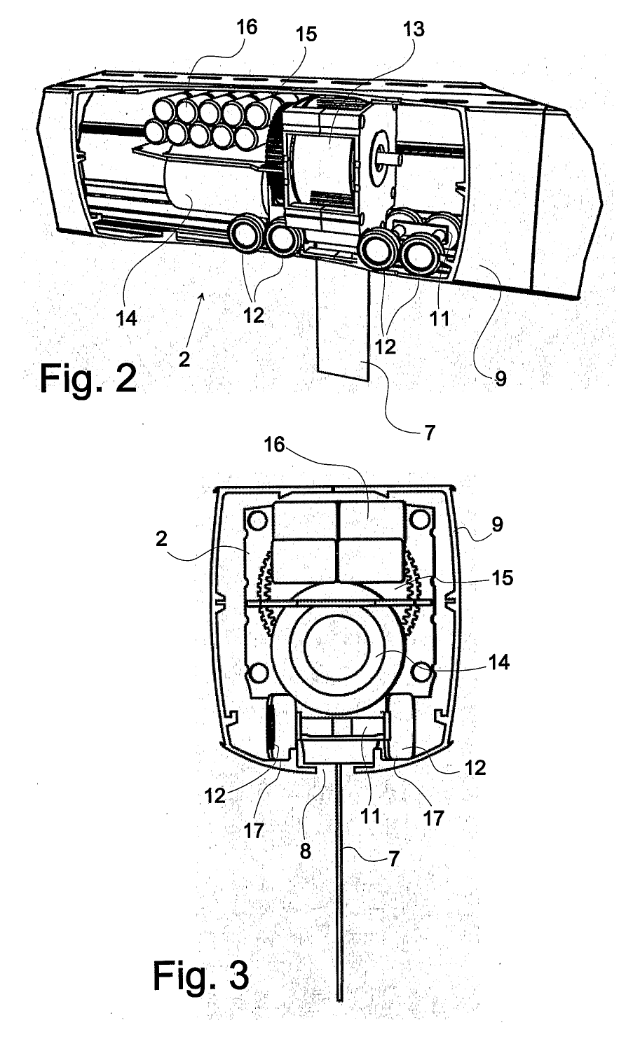

FIG. 2 shows a hoisting apparatus 2 which is built into a rail 9, where the lifting strap 7 is passed out through a slot 8 in the bottom of the rail. The hoisting apparatus 2 is mounted on a trolley 11 provided with wheels 12. When lifting, the lifting strap 7 is rolled up on a reel 13 which is driven by a motor 14, which is in mechanical connection with the reel 13 via a gear system 15. Above the motor 14 appears a battery system 16 which is here made up of a number of battery cells. Charging of these batteries occurs in a not shown charging situation.

The shown variant of the invention is with one single motor 14 which via the gear system 15 may be coupled and uncoupled so that the motor 14 can drive the reel 13 as well as the trolley 11, respectively.

FIG. 3 shows a hoisting system according to the invention viewed in cross-section from the end of the rail 9. At the bottom of the rail 9 appears that the lifting strap 7 is passed through the longitudinal slot 8. The slot 8 may be covered with a kind of sealing so that dust will not settle in the rail, but shown here without any kind of sealing.

The trolley 11, which is built together with the hoisting apparatus 2, runs at the bottom of the rail 9 on wheels 12 which may either be intended for manual pushing or to be driven by the motor 14. The wheels 12 are running on rails 17, ensuring that trolley 11 and hoisting apparatus 2 are always moved in an easy, safe and unencumbered way. The motor 14 is provided with a gear system 15 for operating the reel 13 and the trolley 11, respectively. The battery system 16 appears above the motor.

1-10. (canceled)

11. A hoist system with a hoisting apparatus for hoisting persons, comprising at least one trolley and at least one hoisting apparatus which are integrated and placed assembled in a rail, adapted therefore and wherein the system is driven by at least one motor.

12. Hoist system with a hoisting apparatus according to claim 11, wherein the at least one trolley is a push trolley.

13. Hoist system with a hoisting apparatus according to claim 11, wherein the at least one trolley is a motorized trolley which is driven by an electric motor.

14. Hoist system with a hoisting apparatus according to claim 13, wherein the assembled unit has a second motor for driving the hoisting apparatus.

15. Hoist system with a hoisting apparatus according to claim 11, wherein the trolley and hoisting apparatus are driven by one and the same motor.

16. Hoist system with a hoisting apparatus according to claim 15, wherein between motor and trolley and hoisting apparatus, respectively, there are means for shifting between operating the trolley and operating the hoisting apparatus.

17. Hoist system with a hoisting apparatus according to claim 16, wherein the rail has a longitudinal opening that is provided with a flexible sealing.

18. Hoist system with a hoisting apparatus according to claim 17, wherein the system is supplied with electric energy from at least one battery provided in connection with the assembled unit.

19. Hoist system with a hoisting apparatus according to claim 18, wherein a charging station is arranged in the rail for charging the battery of the system in periods of time when the hoisting system is not utilised.

20. Hoist system with a hoisting apparatus according to claim 17, wherein the system is supplied with electric energy via electrically conducting elements in or at the rail.
